(19) United States
(12) Patent Application Publication
(10) Pub. No.: US 2012/0202580 A1
(43) Pub. Date: Aug. 9, 2012

(54) ELECTRONIC SLOT DEVICE AND METHOD FOR OPERATING THE SAME

(76) Inventor: Damjan Ursic, Kamnik (SI)

(21) Appl. No.: 13/390,802

(22) PCT Filed: Aug. 17, 2010
(86) PCT No.: PCT/EP10/05036

§ 371 Date: Apr. 13, 2012

(30) Foreign Application Priority Data
Aug. 18, 2009 (EP) EP 090 10609.7

(51) Int. Cl. G07F 17/32; A63F 13/00

(52) U.S. Cl. 463/20

(57) ABSTRACT

An electronic slot device and a method for operating the same are disclosed, wherein the device includes one or more player stations, at least one screen to display icons arranged in arrays and at least one electronic control unit; the screen has one or more playing areas corresponding to the one or more player stations. The electronic control unit is programmed to display all the icons available in the game on the screen, at the same time, at all the player stations.

### TECHNICAL FIELD

The present invention relates to an improved electronic slot device and a method for operating the same.

### BACKGROUND

Slot devices are older than 100 years, but the principle of the game remained almost the same.

At the beginning the devices had three parallel reels with symbols that run vertically. The reels spun mechanically by a pull of a lever and stopped at random positions. The player could see only one payline with the combination of symbols. Proper combination won the prize. Later on, a mechanical lever was substituted by an electromotor.

A subsequent improvement is brought to slot machines by the use of a random number generator (RNG). The RNG determines the spin of the reels, the stop position of each reel and the combination of symbols at the payline. The reels come to a stop by means of a step motor.

In more recent years, the video based slot machines were introduced: reels, with symbols/icons running vertically, are simulated on a video screen. Such video slots offer also huge variations of paylines and winning prizes. The number of reels with a virtual horizontal axis increased from three to five, or to even more. And also, the video window of the slot device is in course of time enlarged and enables the betting on more paylines, e.g. combinations of symbols/icons aligned according to horizontal, diagonal, zig-zag lines or the like.

Another step forward makes the introduction of the so-called “bonus”, which is activated when certain symbols/icons appear in a winning combination. Bonus offers an additional game (Wheel of fortune, Roulette, or the like) on an additional display, usually positioned above the primary display of the slot machine. This latest evolution brought the linking of the individual devices into groups, in casinos or even across multiple casinos, offering the players a shared participation in the bonus game or giving the players the opportunity to win the Jackpot.

Each player plays his own machine, but joins the group of players at the bonus game or Jackpot. The primary game made available by the slot device and its results are commonly determined by an individual RNG in each gaming device. However, the bonus game is controlled by one generator only for all devices included in the group.

The bonus game usually differs from the primary game. For example, known slot devices named “Ebay”, produced by International Game Technology (IGT), are linked together (each slot device has its own display) and share a large display positioned above them. If one of the players in the group wins the bonus, the reels with large symbols and paylines of the bonus game appear on the shared display. Only at this moment the game becomes a group game.

In a recent product made by the company Atlantic City Coin & Slot, whenever the bonus is won, a coin triggers one wheel with fixed symbols of bank notes to spin. The wheel stops by means of a random number generator. Then the position of the stopped wheel and the prizes won can be read. In this case, the combination of symbols can not be shown, because there is only one wheel. The company IGT offers a similar slot device, named “Wheel of Fortune”.

Some producers have already constructed slot devices with two monitors and a bench for two persons for enabling two players to play close to each other.

Nowadays, slot devices cover more than 70% of all gaming devices in use. As stated above, the most diffused electronic slot devices offer a single player station and comprise a mechanical or electronic shift of parallel series of reels with printed pictures or icons. Among some latest electronic slot devices, there is an electronic connection which enables an optional limited group participation in the game.

However, a lot of people come in groups to a casino, but then they split and each plays his own game, concentrates on his own display and presses his own buttons; there is no mutual involvement or fun.

With the known electronic slot devices, group playing is offered only when someone wins a bonus, but then the players return back to their own game again. What is missing is the uninterrupted and physical communication among the players. Slot gaming is very attractive, but still individual. A group of friends, for example one or two couples, want to play together, have fun together in every stage of the game and not only here and there at bonus games.

It should also be noted that what hinders playing in groups, is a physical construction of the devices, and huge devices for the bonuses, that are positioned above the group of player stations, which is obvious especially when players sit opposite to each other. The known slot devices offering an additional group bonus take a lot of space which is often not available in the casinos and is not very advantageous from an economical point of view.

In general, prior art from multiplayer community slot devices which share the same game at the same time and share the icons on the arrays, are constructed in the way that physical barriers unable players or observers the clear visibility of all icons shared and played by players at the same time and clear visibility of all players winning results in the playing group. That community devices construction also disturb the players the clear view to other players. Therefore the communication among the players is limited and the game is not attractive enough for players and observers.

US-A-2003/0148804 discloses a multi player game machine which allows at least two players to play the game simultaneously. The machine has a plurality of reels having a circumferential length and rotating about a vertical axis. However, due to the tower shaped structure, each player can share the events of the games only with the adjacent players.

A first object of the present invention is to propose an electronic slot device and a method for operating the same that allow the game to appear more attractive not only for a single player, but also for a group of players and/or for people not directly involved in the play.

Another object of the present invention is to propose an electronic slot device and a method for operating the same which allow to make easier to modify the appearance of the game and/or the number of player stations of the device without requiring heavy computing intervention and/or new licenses from the supervising jurisdiction.

A further object of the present invention is to propose an electronic slot device which can be easily installed and operated not only in casinos, but also in other kind of public places where amusements and/or games of chance can be played.

Still another object of the present invention is to propose an electronic slot device and a method for operating the same which allow the players to communicate with each other during the game, and have fun together by sharing the same game and reading the combinations of symbols displayed by the same device.

### SUMMARY

These objects are achieved by means of the present invention, which relates to an electronic slot device according to claim 1 and a method for operating the same according to claim 10. Further peculiar features of the present invention are set out in the respective dependent claims.

An electronic slot device according to the present invention includes one or more player stations, at least one screen to display icons arranged in arrays and at least one electronic control unit; the at least one screen has one or more playing areas corresponding to the one or more player stations. The at least one electronic control unit is programmed to display all the icons available in the game on the at least one screen, at the same time, at all the player stations.

The present invention enables a completely new dimension in playing the slot devices, both by a single player or a group of players. One and the same game with icons that move from one player station to another can be played by one or more players at the same time. Indeed, each of the player stations can be switched from a community game mode to a single player game mode.

In other words, all icons available in the game can be used by a single player on one player station, or can be shared by a group of players on the player stations. For example, when used by a single player, a slot device according to the invention enable the player betting on much more pay-lines (as much as 5 times more) as standard single player slot machines. When used as a multiplayer slot device, players will get a new possibility to play the game observing all icons in all player stations, with expectation to results at all player stations. Such a new slot device will attracts observers from distance and involves them in the course of the game.

Preferably, at least one game computer unit is provided in the slot device according to the invention to run a first program which controls the game; a screen computer unit is further provided to run a second program which controls at least the movement of the icons on the at least one screen, on the basis of data and commands received by the first program.

A slot device according to this aspect of the invention is therefore much easier to program and obtain a license for different jurisdictions because each single player station has the same program that controls game results, regardless how many player stations are virtually provided by the slot device. The second program has no impact on the game but controls the display of the icons for attractive reasons only.

This is a great advantage for manufacturers of gaming devices and provides a versatile solution for many different embodiments. For example, the slot device according to the invention can be made as a single gaming unit, with a fixed number of player stations, or it can also be composed of modular units connected together.

A slot device according to the invention can be simply modified in terms of icons displayed, number of modular units/player stations, displayed advertising etc., without requiring a new license for the game software.

In the embodiments having a fixed number of player stations, the game computer unit and the screen computer unit can consist of a single computer unit which runs both the first program to control the game of all the player stations and the second program to control the at least one screen for all the player stations. This single computer unit also incorporates a RNG.

Alternatively, one or more game computer units are provided for the corresponding one or more player stations to run the same first program in each of the player stations. It should be intended that each game computer unit has its own RNG. In this case, the screen computer unit which runs the second program to control the at least one screen for all the player stations is a distinct computer unit with respect to the game computer units. This is for example the case of a slot device consisting of modular units connected to each other: in other words, each modular unit includes a game computer unit to run a same first program to control the game, and all the modular units are connected to a single screen computer unit which runs a second program to control the at least one screen for all the modular units.

Interface means are provided to interact with the one or more player stations and/or the one or more playing areas. For example, the interface means include a player terminal at each player station with input/output units for coins, bills, tickets, cards (e.g. smart cards) to enable to bet and collect winnings and/or store data as well. Each player terminal can interact with one or more playing areas of the screen, each area having separate results of icons on the paylines.

Interface means can also include “gesture recognition” systems as well. These systems have motion sensors or cameras with objet/motion/gesture recognition software and/or computer vision algorithms to interpret sign language. In other words, gesture recognition is a possible way for interacting with the computer(s) of the slot devices in order to allow such devices to understand human body language, as well as identification and recognition of posture, gait, proxemics, and human behaviors.

The present invention can be carried out in a wide variety of embodiments, also in case the available space could be constraint.

For example, the device can be integrated in, or made in the form of, a table that can be used in a restaurant, a bar, a club or the like. In this case, all icons available in the game can be perfectly visible to all the players in the game, as well as to people watching the plane of the table. The game wins in its attraction and transparency.

According to another possible embodiment, the device can be integrated wholly or partly in a wall, or it can consists substantially of a video wall. In other words, the at least one screen can be made in the form of a video wall, or it can be integrated in, or supported by, a wall and each player station can have a player terminal separated or integrated in the wall. In this embodiment the arrays of icons can be shifted for example in horizontal direction, thus giving an impression of a long band, wheel or the like which is spinning or shifting from one player station to another.

According to a preferred embodiment of the invention, the at least one screen has a flat shape and a size sufficient to display at the same time all the icons available in the game at all the player stations.

Preferably, the player stations have a flat shaped screen without any part of the device interposed between the player stations and the flat shaped screen to enable a player to have visible control, at the same time, to all the icons available in the game at all the player stations, and/or to enable all the players to have visibility to all the other players and all said player stations.

Other embodiments can be envisaged according to the present invention, such as slot devices made in the form of a plurality of cabinets close to each other or mutually spaced, as well in the form of a parallelepiped column with any kind of circular, conical, or polygonal base.

In all the embodiments of the present invention, the icons can be electronically displayed on a larger screen consisting of a single monitor or several individual monitors or, alternatively, the icons can be projected both on a vertical screen, such as a wall, a window or the like, and a horizontal screen such as a table or also a portion of a floor.

A method is also provided for operating an electronic slot device having one or more player stations, at least one screen to display icons arranged in arrays and at least one electronic control unit, the at least one screen having one or more playing areas corresponding to the one or more player stations. According to the present invention, all the icons available in the game are displayed on the at least one screen, at the same time, at all the player stations.

More particularly, the method includes the steps of:

a) running a first program on a game computer unit to control the game;

b) running a second program on a screen computer unit to run a second program which controls at least the movement of the icons on the at least one screen on the basis of data and commands received by the first program.

The first program sends data to the second program in order to provide the information of the game that can be displayed on the screen, for example icons, paylines and the like.

In particular, each array of icons of a previous session of the game is stored in a corresponding first temporary memory of the screen computer unit and each array of icons of a new session of the game is stored in a corresponding second temporary memory of the screen computer unit.

At the start of a new game session, the arrays of icons stored in the first temporary memory and currently shown on the at least one screen are moved independently to each other from one player station to another with an increasing speed, until a maximum speed is reached in which the icons become unperceivable.

During a new game session, each array of icons corresponding to the result of the new session game is calculated by the first program and stored in the second temporary memory without being shown on the at least one screen.

At the end of a new game session, the data of the first temporary memory are replaced by the data of the second temporary memory while the icons of the arrays shown on the at least one screen are still unperceivable, and then each array of icons corresponding to the result of the new session game is moved independently to the others from one player station to another with a decreasing speed until each array stops.

The game can also be controlled in order to increasingly accelerate or decelerate some arrays with respect to the others, thus improving the visual effect of the images displayed on the screen(s).

When the arrays of icons stop, the winning picture can be seen. The winning picture is also shown at momentarily non-occupied player stations. In addition, one or more moving arrays can further be provided as a bonus game for one or more players.

The start of the game can begin automatically with time shift or it can be triggered by one or more players or operators. The game stops at the same moment at all player stations. In other words, the game can be started automatically and in time intervals on one or more slot devices for one or more players, or the game can be triggered by one player or operator for all player stations.

According to an advantageous aspect of the invention, a third program can be provided to display multimedia contents including commercials, video spots movies or other kind of entertainment/commercial media on the at least one screen. The multimedia contents can be displayed on the at least one screen as a background during the course of a game, or before a game starts or after a game is finished.

The multimedia contents can also be displayed on the at least one screen in correspondence of playing areas not involved by the game, for example transition portions of screen where icons are usually shown between adjacent playing areas.

The third program to display multimedia contents can be run on the screen computer unit or, alternatively, on a third computer unit which is anyway different from the game computer unit.

The electronic slot device according to the present invention can be implemented as a device for playing a primary game, as a device for playing a bonus game to be mounted on already installed slot machines, or it can also provide a combination of both a primary and a bonus game.

### BRIEF DESCRIPTION OF THE DRAWINGS

Further advantages and characteristics of the present invention will be more apparent from the description below, provided with reference to the accompanying schematic drawings purely by way of a non-limiting example, wherein:

FIG. 1 is an isometric view of a possible embodiment of an electronic slot device according to the present invention in the form of a square table;

FIG. 2 is a plan view of the electronic slot device shown in FIG. 1;

FIG. 3 is an isometric view of another embodiment of an electronic slot device according to the present invention in the form of a round table;

FIG. 4 is a plan view of the electronic slot device shown in FIG. 3;

FIG. 5A is an isometric view of a further embodiment of an electronic slot device according to the present invention in the form of a round table;

FIG. 5B is a plan view of the electronic slot device shown in FIG. 5A;

FIG. 6A is an isometric view of a further embodiment of an electronic slot device according to the present invention in the form of a round table;

FIG. 6B is a plan view of the electronic slot device shown in FIG. 6A;

FIG. 7A is an isometric view of the embodiment of an electronic slot device according to the present invention in the form of a rectangular table made as a composition of square tables;

FIG. 7B is a plan view of the electronic slot device shown in FIG. 7A;

FIG. 7C is an isometric view of another embodiment of an electronic slot device according to the present invention in the form of a table made as a composition of square tables;

FIG. 7D is a plan view of the electronic slot device shown in FIG. 7C;

FIG. 8 is a plan view of the embodiment of an electronic slot device according to the present invention in the form of a table having a curved round shape;

FIG. 9 is a plan view of another embodiment of an electronic slot devices according to the present invention in the form of a desk/counter structure;

FIGS. 10 and 11 are plan views of possible embodiments of electronic slot devices according to the present invention including two structures of FIG. 9 in different configurations;

FIG. 12 is a plan view of another embodiment of the electronic slot device similar to that of FIG. 9 with separate player stations;

FIG. 13 is a plan view of another embodiment of an electronic slot device of the present invention with player stations arranged in a wave-like configuration;

FIG. 14 is a front view of an embodiment of the electronic slot device according to the present invention in the form of a vertical wall;

FIGS. 15A and 15B are plan views of possible embodiments of the electronic slot devices shown in FIG. 14;

FIG. 16 is an isometric view of another embodiment of the electronic slot device according to the present invention in the form of a curved wall;

FIG. 17 is a front view of another possible embodiment of the electronic slot device in the form of cabinets closed to each other;

FIG. 18 is a front view of another possible embodiment of the electronic slot device in the form of separate cabinets;

FIGS. 19 and 20 are side views of possible embodiments of the electronic slot devices shown in FIGS. 17 and 18;

FIG. 21 is a further possible embodiment of an electronic slot device according to the present invention in the form of a column with circular base;

FIG. 22 is a plan view of the embodiment shown in FIG. 21;

FIGS. 23A, 23B and 23C are isometric views of other possible embodiments of an electronic slot device according to the present invention in the form of a column with triangular base;

FIGS. 24A, 24B and 24C are isometric views of other possible embodiments of an electronic slot device according to the present invention in the form of a column with octagonal base;

FIG. 25 is a further possible embodiment of an electronic slot device according to the present invention in the form of a column with a base extending along a curved contour;

FIG. 26 is a side elevation view an electronic slot device according to the present invention in which the screen is made in the form of a drum;

FIG. 27 is a front elevation view of the electronic slot device of FIG. 26;

FIG. 28 is a top plan view of the electronic slot device of FIG. 26;

FIG. 29 is an isometric view of another embodiment of the electronic slot device according to the present invention integrated into a floor; and

FIG. 30 is a flow diagram which shows the operation of a slot device according to the method of the present invention.

### DETAILED DESCRIPTION

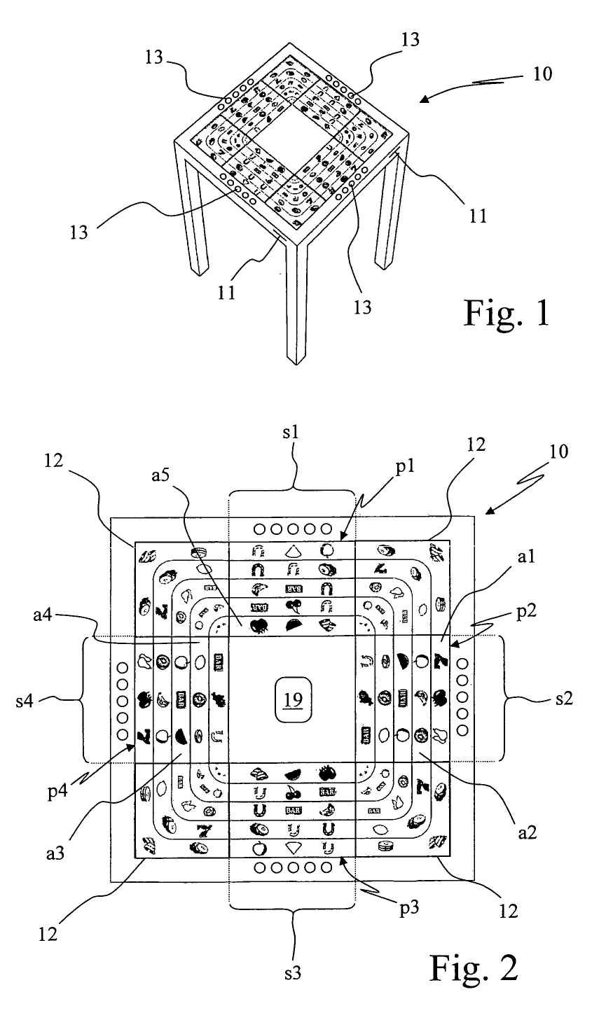

FIGS. 1 and 2 show an electronic slot device according to the present invention in the form of a square table 10 which is provided with slots 11 for the introduction of coins or a card, e.g. a smart card or the like. Here, and in other similar embodiments of the device, also a single slot 11 can be provided for all the player stations of the same device.

As shown in FIG. 2, due to the square configuration of the table 10, there are provided four player stations s1, s2, s3 and s4 in correspondence of each side of the square shape. Corresponding playing areas p1-p4 are indentified and delimited on the screen in front of each player station s1-s4 and are separated by transition areas 12 (here represented in a semitransparent way only to put them in evidence) where icons are anyway displayed to make the appearance of a continuous flow when they moves from a player station to another. Transition areas 12 can also be used to display multimedia contents, as for example commercials, video spots movies or other kind of entertainment/commercial media before the start of a game, after the stop of a game or also during the game, for example when the icons are moved without being perceivable on the screen.

An electronic control unit 19, which includes a random number generator (RNG), is incorporated into the table 10 to control the game and move/display a plurality of icons arranged for example in five arrays a1, a2, a3, a4 and a5 which move parallel and independently to each other from one player station to another. Arrays of icons have the same function of the reels or stripes of the traditional slot machines but in this case all icons involved in the game are shown on the screen of the table 10. In this embodiment, due to the fixed number of player stations, the control unit 19 can be a single computer unit which runs both the first program to control the game of all the player stations and the second program to control the screen.

All the arrays a1-a5 can be shifted in the same direction or, alternatively, one or more arrays can be shifted in an opposite direction with respect to an adjacent array. For example, with reference to FIG. 2, arrays a1, a3 and a5 can be shifted in a clockwise direction and arrays a2 and a4 can be shifted in the counter-clockwise direction, or vice-versa.

Pushbuttons 13 can be provided on the edges of the table 10 to allow each player to interact with the device, e.g. to place bets, start/stop the game or quit the game.

Alternatively, other interface means can be used, as for example a touch screen which allows to display the icons and, in the meantime, to interact with the device by simply touching some predetermined areas of the screen or, as already stated above, gesture recognition systems.

For protecting the screen, a transparent plate made of glass, acril-polycarbonat or any other transparent material is mounted above the screen. In the space between the screen and the protecting plate, transparent electroluminescent paylines are fixed and connected to transparent conductors. The paylines appear visible only if they are chosen by the player or to show the result of the game, otherwise they are invisible.

Paylines of this device function in a similar way to those in ordinary slot devices and are defined in straight lines, in curves or in refracted lines as is common also with ordinary slot devices.

Paylines are predetermined or can be chosen by a player by pressing one or more pushbuttons 13 before the start of the game. The payline with the prize winning combination of the icons becomes visible, blinks or is lighted up. Paylines are brought onto the transparent material as transparent conductors and as transparent electroluminescent elements, or as mini LED or LCD.

The icons can be shown by an electronic video display (or monitor) or by several displays tiled together (e.g. LCD, plasma, organic or other electroluminescent displays) or can belong to an image projected on the device's periphery. In case of video displays and video projections, the paylines are a part of the basic picture of the game and thus the additional transparent electroluminescent layer is not necessarily required. In this case, as well in all other embodiments herein disclosed where the icons are projected and/or displayed electronically, icons must not necessarily be held in fixed positions and can also be moved in different positions of the array during the game in order to change continuously the sequence of icons in each array.

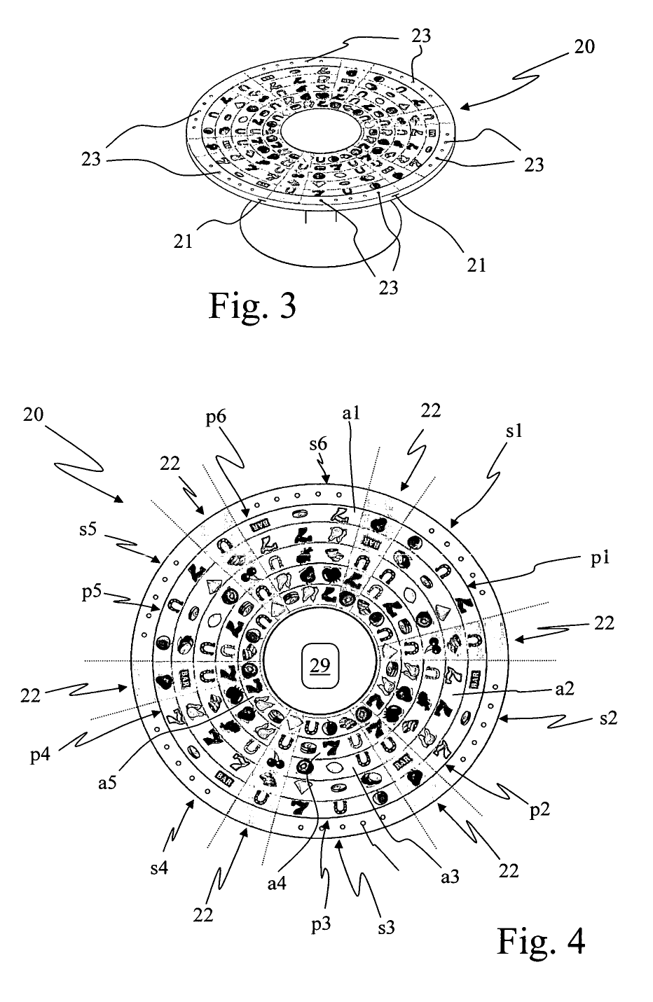

FIGS. 3 and 4 show another embodiment of an electronic slot device 20 in the form of a round table supported by a central column. The plan view of FIG. 4 shows the game configuration of this embodiment 20.

There are provided for example six player stations s1-s6 around the edge of the circular shape of table 20. As in the other table embodiments previously disclosed, playing areas p1-p6 are indentified and delimited on the screen in front of each player station s1-s6 and are separated by transition areas 22 where icons are anyway displayed to make the appearance of a continuous flow when they moves from a player station to another. Transition areas 22 can also be used to display multimedia contents.

An electronic control unit 29, which includes a random number generator (RNG), is incorporated into the round table 20 to control the game and move/display a plurality of icons arranged in five arrays a1-a5 which move parallel and independently to each other from one player station to another. All icons involved in the game are shown on the screen of the round table 20. Also in this case, due to the fixed number of player stations, the control unit 29 can be a single computer unit which runs both the first program to control the game of all the player stations and the second program to control the screen.

All the arrays a1-a5 can be shifted in the same direction or, alternatively, one or more arrays can be shifted in an opposite direction with respect to an adjacent array. For example arrays a1, a3 and a5 can be shifted in a clockwise direction and arrays a2 and a4 can be shifted in the counter-clockwise direction, or vice-versa.

As shown in FIG. 3, there are provided slots 21 for introducing coins or a card, e.g. a smart card or the like, as well as pushbuttons 23 to allow each player to interact with the device. Other interface means can be used instead of pushbuttons 23, as for example a touch screen, a gesture recognition system or the like.

A transparent plate made of glass, acril-polycarbonat or any other transparent material can be mounted above the screen for protecting the same. In the space between the screen the protecting plate, transparent electroluminescent paylines are fixed and connected to transparent conductors. The paylines appear visible only if they are chosen by the player or to show the result of the game, otherwise they are invisible.

The screen can consist of a single monitor of a plurality of monitors tiled together such as LCD, plasma, organic or any other electroluminescent display; alternatively, the screen can be a flat table top where images are projected. In case of video displays and video projections, the paylines are a part of the basic picture of the game and thus the additional transparent electroluminescent layer is not necessary required.

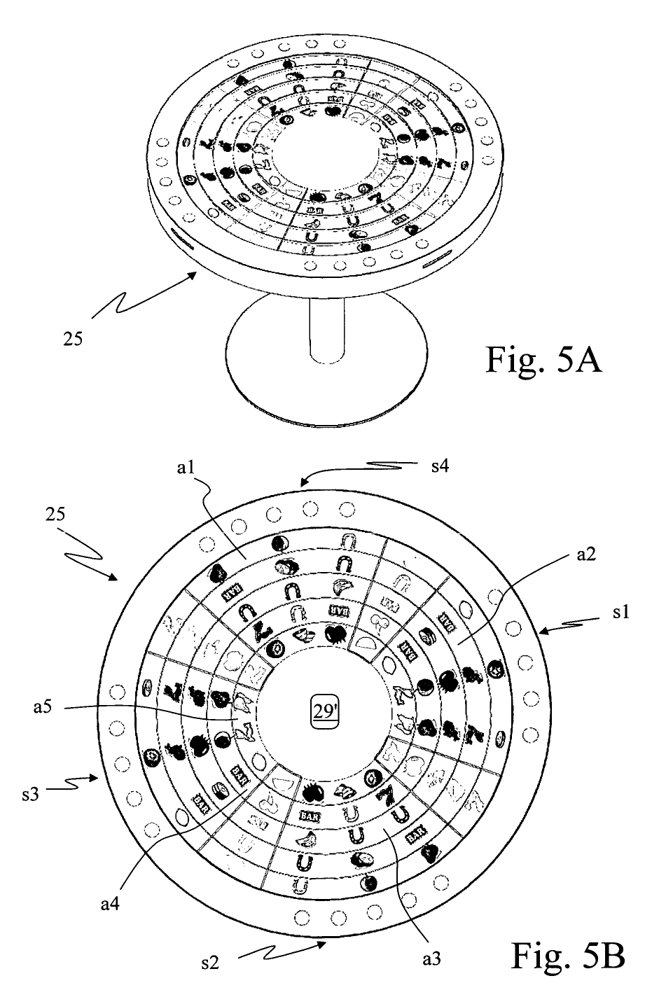

FIGS. 5A and 5B show an alternative embodiment of a device 25 in the form of a round table with the same number of arrays a1-a5 of icons of a main or primary game, where four player stations s1-s4 are provided. An electronic control unit 29′ allows to control the game and the screen.

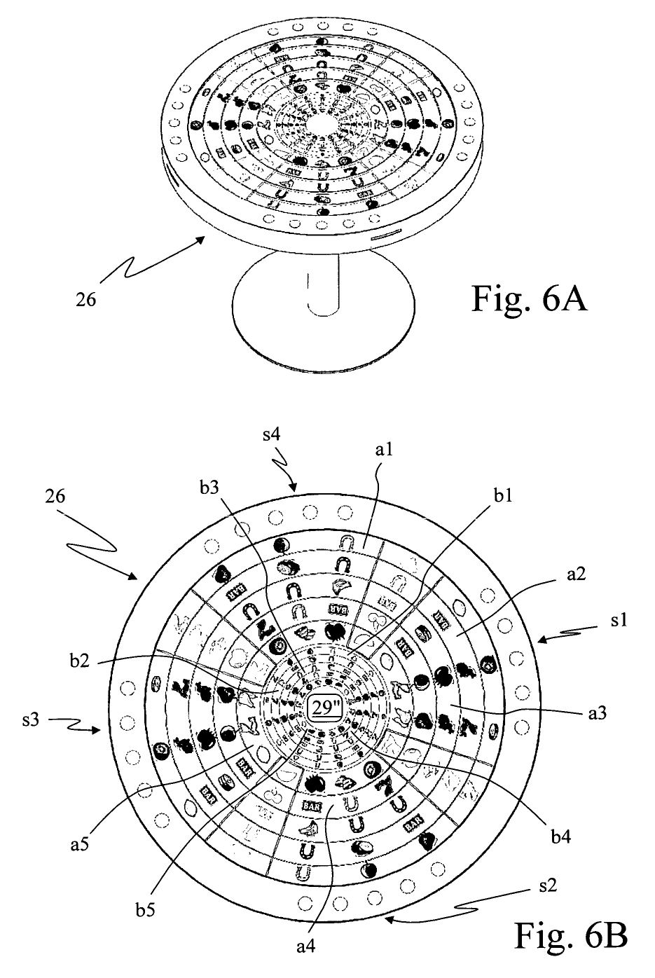

FIGS. 6A and 6B shows an embodiment of a device similar to that of FIGS. 5A and 5B, where in addition to arrays a1-a5 of the primary game there are further shown five arrays b1-b5 for providing a “bonus” game. Both the primary game and the bonus game are controlled by an electronic control unit 29″.

All the embodiments shown above can be used by a single player or a plurality of players. A single player can choose to play at only one player station or, alternatively, at two or more player stations: he/she and can view all icons made available by the game and can also choose to bet on much more pay-lines as standard single player slot machines. When used by multiple players, the horizontal flat construction of the screen, without any part of the device interposed between the player stations and the screen, enables all players to see each other and have possibility to communicate and have fun together as well.

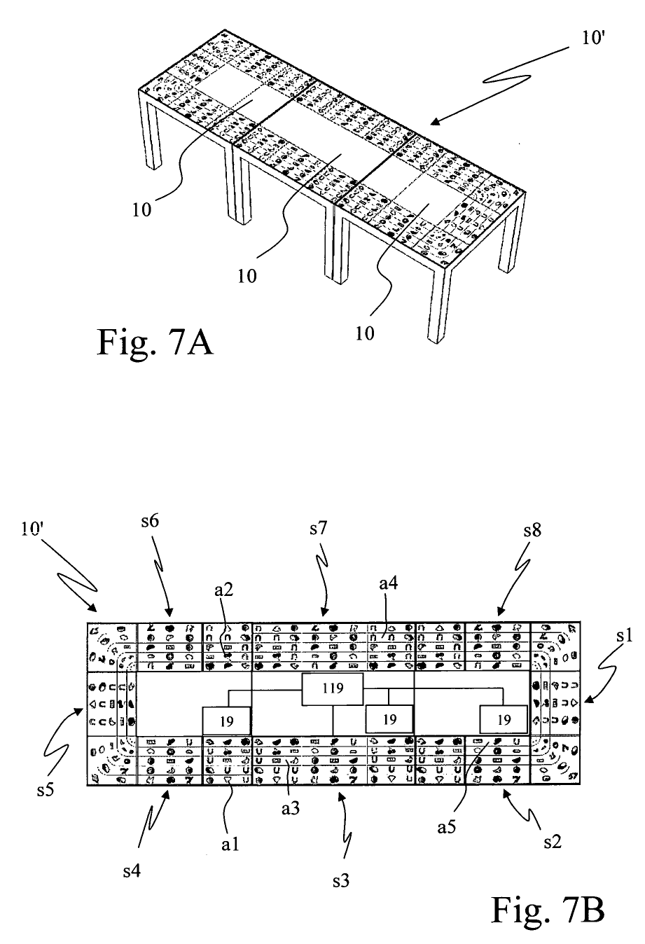

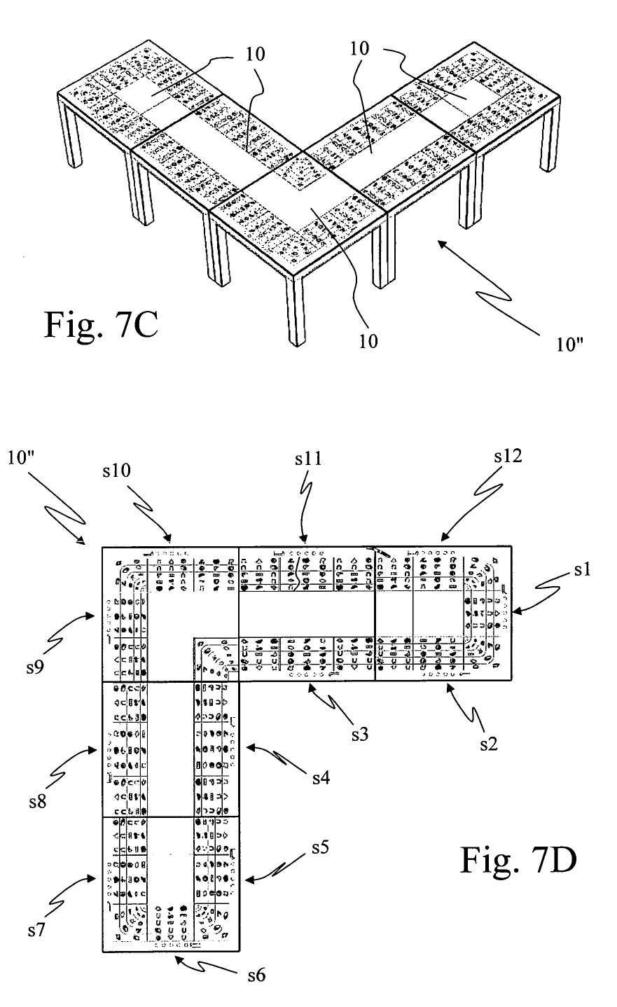

FIGS. 7A and 7B show an example of another embodiment of an electronic slot device in the form of a table 10′ having rectangular shape and made as a modular composition of three square tables 10 (FIGS. 1 and 2) aligned side by side. The device has eight player stations s1-s8 and a combination of five arrays a1-a5.

Each table module 10 has its own game computer unit 19 which runs a first program to control the game of the player stations belonging to the same module, and a common screen computer unit 119 is provided to control the display of icons and paylines on the composed screen. The recognition of any module linked to the others can be set as an automatic feature of each module 10, or made available by the screen computer unit 119. Alternatively, the recognition of modules can be manually programmed by an operator during the installation phase of the slot device or of any new module to be connected thereto. Anyway, as in the previous embodiments, all the icons involved in the game are displayed on the flat screen and can be seen from all directions at all the player stations.

Different modular compositions of square tables can be designed as a function of the space available in the site of installation. An example of a different composition of a device 10″ is shown in FIGS. 7C and 7D, where twelve player stations s1-s12 are made available by linking five table modules 10. As stated above, the number of the player stations and the number of the arrays in each device can depend on the shape and size of the table.

The same rectangular shapes shown in FIGS. 7A-7D could have round corners, with or without transition areas on the screen in correspondence of the corners, and the paths of each array can be curved in correspondence of the corners.

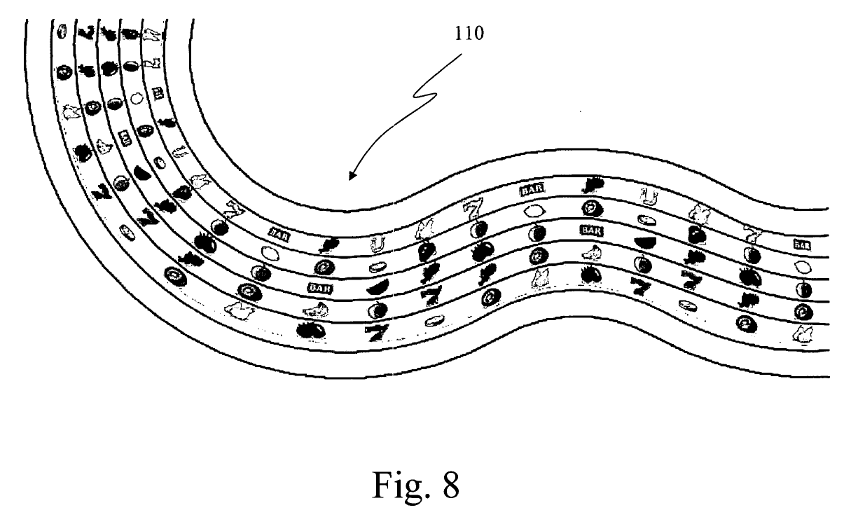

Another example of a possible embodiment is shown in FIG. 8, where the device 110 can also be made in the form of a table having a flat screen of arbitrarily curved shape.

An open curved shape is shown as an example in FIG. 8, but a table in the form of a closed curved shape can also be envisaged.

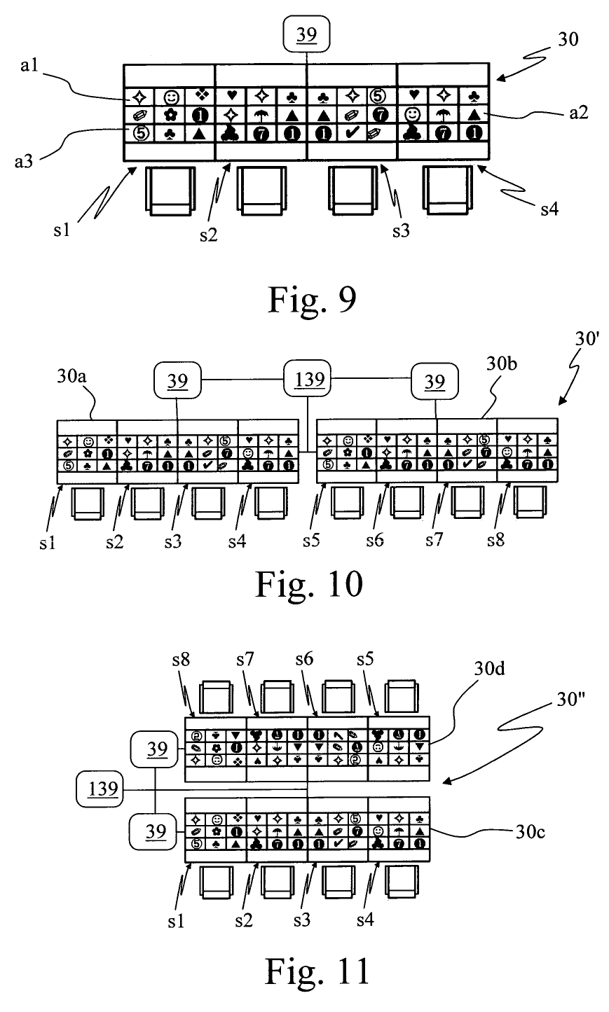

FIG. 9 shows another embodiment of an electronic slot device 30 made in the form of a desk or counter having four player stations s1-s4 and three arrays of icons a1-a3 which moves parallel and independently to each other. An electronic control unit 39, which includes a random number generator (RNG), is incorporated into the table 10 to control the game and move/display the icons arranged on the arrays. Due to the fixed number of player stations, the control unit 39 can be a single computer unit which runs both the first program to control the game of all the player stations and the second program to control the screen.

Suitable means (not shown) can be provided to allow each player to interact with the game, such as pushbuttons, slots for coin or cards, touch-screens or the like as already disclosed for the previous embodiments.

Paylines of this device function similar to those in ordinary slot devices, i.e. they can be predetermined or chosen by a player by pressing for example the pushbuttons before the start of the game. The paylines are characterized either on the inner side or in the transparent housing/plate. The payline with the prize winning combination of the icons becomes visible, blinks or is lighted up. Payline lines are brought onto the transparent material such as transparent conductors, transparent electroluminescent elements, mini LEDs, LCD or the like.

The screen of the slot device of FIG. 9 can be for example a video display (LCD, plasma, organic or other electroluminescent displays) or a screen for images projected on the device's periphery or by several displays tiled together. In case of video displays and video projections, the paylines are a part of the basic picture of the game and thus the additional transparent electroluminescent layer is not necessary required.

The desk/counter slot device shown in FIG. 9 can be used as a modular unit to form different combinations, such as those of FIGS. 10 and 11.

The desk/counter slot device 30′ shown in FIG. 10 includes for example two modular units 30a and 30b placed side by side. Each modular unit has its own game control unit 39, each having a RNG, and a distinct screen computer unit 139 is provided. The icons run for example from the first player station s1 to the last player station s8 and again from the first to the last, or vice-versa. More than two modular units can be combined side by side in this embodiment depending on the space available at site of installation.

The desk/counter slot device 30″ shown in FIG. 11 includes two modular units 30c and 30d facing to each other. In this case too, each modular unit has its own game control unit 39, each having a RNG, and a distinct screen computer unit 139 is provided. Icons runs from the first player station s1 to the last player station s4 of the modular unit 30c, then shifts on the first player station s5 and runs up to the last player station s8 of modular unit 30d and then again from the first player station s1 to the last player station s4, and so on (or vice-versa).

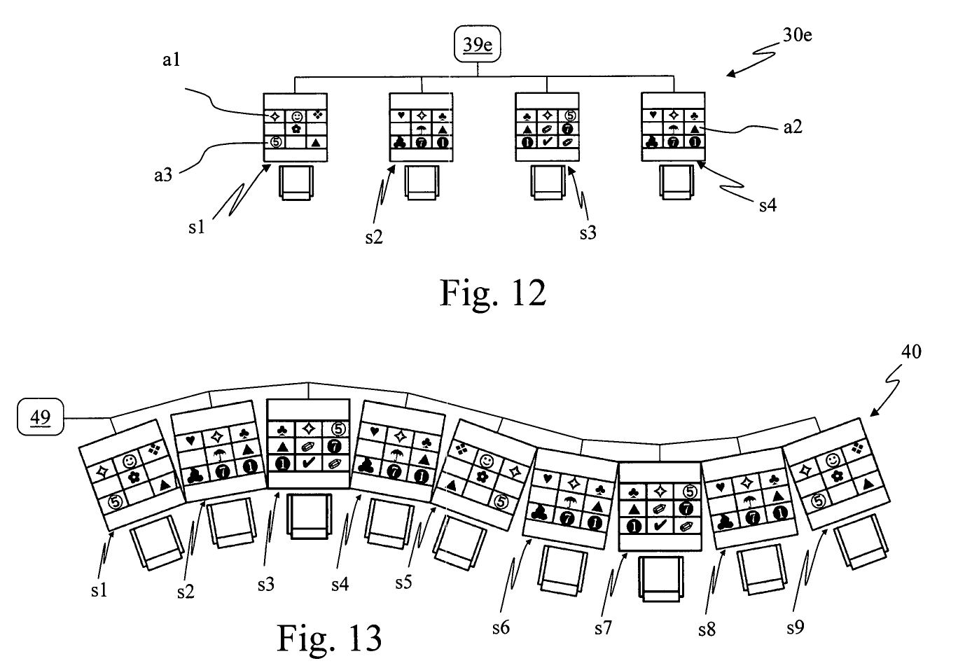

Another embodiment, in electronic version, of a desk/counter slot device is shown in FIG. 12, where the slot device 30e is substantially the same of that in FIG. 9 but with separate player stations s1-s4. The flow of the icons in each of the arrays a1-a3 can be the same already disclosed for the embodiment of FIG. 9, i.e. from the first player station s1 to the last player station s4 and again from the first to the last, or vice-versa.

In this case, the device can be provided with a single electronic computer unit 39e which runs both the first program to control the game of all the player stations and the second program to control the screen. Alternatively, if the slot device 30e is produced in the modular version, each player station s1-s4 should have its own game computer unit and a different screen computer unit should be provided to control the screen.

FIG. 13 shows another possible embodiment on a multiplayer electronic slot device 40 in the form of a desk/counter with nine player stations s1-s9 installed in a wave-like configuration. All the player stations and the relevant monitors can be controlled by a single electronic control unit 49 or, in modular version, by a game computer unit for each player station and a distinct computer unit to control the screen.

All the devices shown in the embodiments of FIGS. 9-13 are shown with a horizontal flat screens, but they can also be made for example with each player station in the form of a vertical and/or slant-top traditional cabinet.

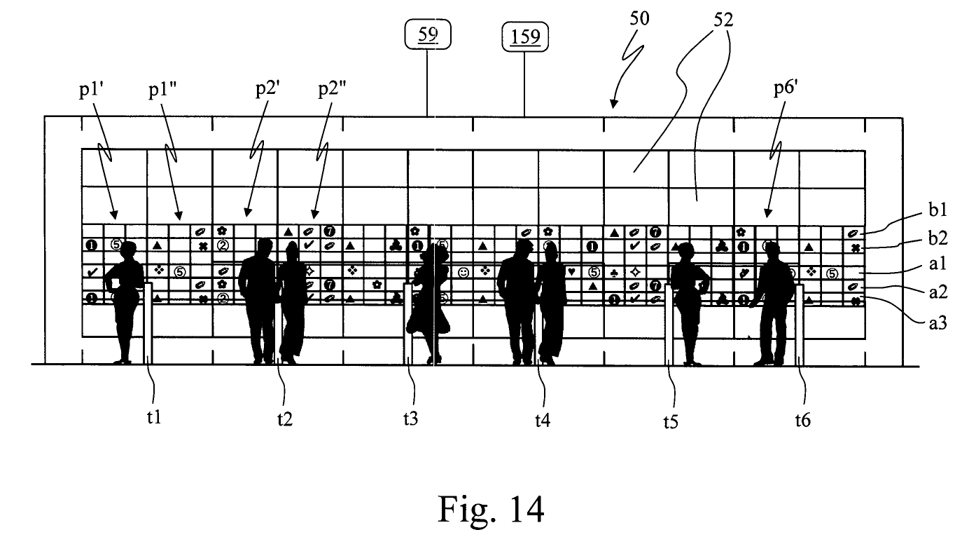

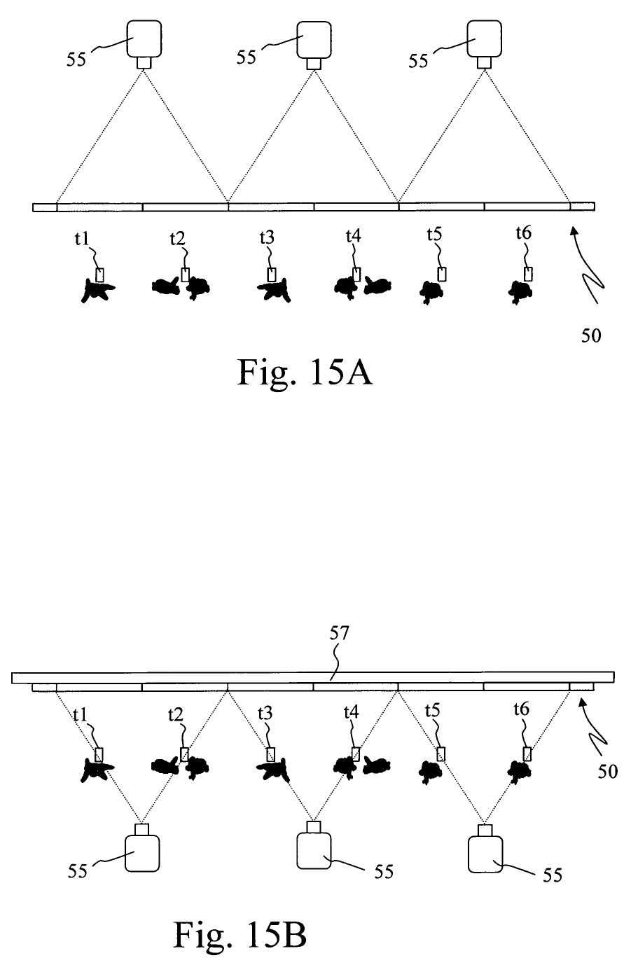

Another embodiment of the present invention can be seen in FIG. 14, where the electronic slot device 50 is made in the form of, or integrated into, a wall or supported by a wall. Indeed, a “video wall” slot device can be installed as a self-standing element that can be place anywhere in a room (FIG. 15A) or it can be installed on a supporting wall 57 with mounted videos (FIG. 15B). The displays can be mounted upon the entire wall or only upon a part of it.

The video wall slot device 50 can consist of one large display/monitor or of a plurality of displays/monitors tiled together, as is usual at video walls. Instead of displays or monitors, rear or front projection can also be used. An electronic control unit 59 with a single random number generator is provided to control the game and the display(s) or monitor(s).

In the embodiment shown on FIG. 14, the video wall slot device 50 can be set to enable the playing of one basic game (primary game) identified by the arrays of icons a1-a3 and, above it, an additional game (bonus game) identified by the arrays of icons b1, b2.

In front of the video wall 50 there are installed player terminals t1-t6, each of which allows one or two players to interact with the game. Each player terminal t1-t6 have preferably a pair of input/output units for coins, bills, tickets, cards or the like, and each terminal can be provided with a shelf for holding cup and glasses. In other words, two adjacent player stations can share the same player terminal.

Player terminals t1-t6 further allow to choose the corresponding playing areas. For example, the player at the terminal t1 of FIG. 14 can play on both playing areas p1′ and p1″, each player of the couple at the terminal t2 can play on the facing playing area p2′ and p2″ respectively, while the player at terminal t6 can play only on the playing area p6′.

The game can be supplemented by multimedia contents, such as video spots or film shots or any other video shots or advertisements. The video wall slot device is seen from far away and spices the character of the ambient. For this purpose, there are provided a game computer unit 59 and a distinct computer unit 159 to control the display of the multimedia contents on portions 52 of the screen which are not involved in the game. Alternatively, the multimedia contents can be displayed as a background images or videos on all the available portions of the screen.

As already stated, instead of electronically displaying images on monitors, icons and video presentations can also be projected, for example by using one or more projectors 55 placed behind (FIG. 15A) or in front (FIG. 15B) of the video wall 50.

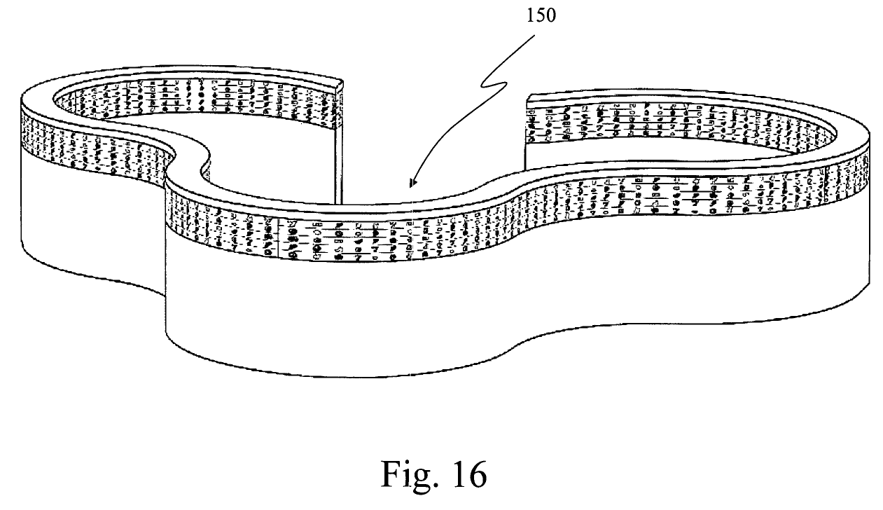

FIG. 16 shows another embodiment of a device 150 according to the present invention in the form of a wall having a curved shape where player stations can be located in correspondence of both the side of the walls. Alternatively, player stations can be placed only in the internal space delimited by the wall while the external side of the wall can be used only to display moving icons or video spots for entertainment purpose. In this case too it is possible to use rear and front projection of icons and video presentation.

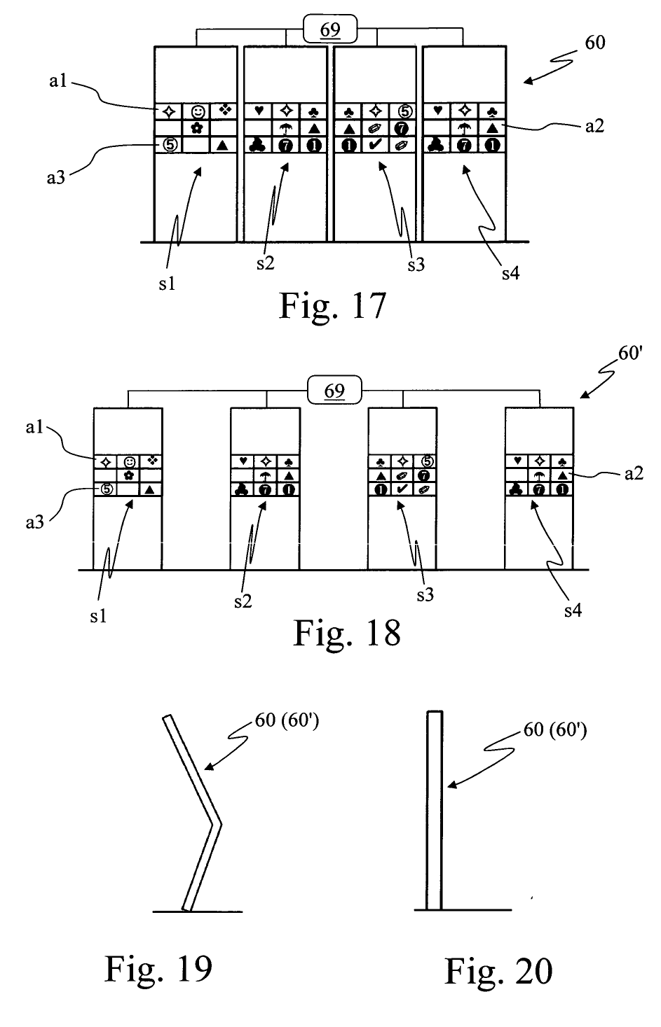

Other embodiments of slot devices according to present invention are shown on FIGS. 17 to 20.

The slot device 60 in FIG. 17 consists of four “cabinets” placed side by side in a close relationship and controlled by a single computer unit 69 including a random number generator. Each cabinet provides a corresponding player station s1-s4

All the icons of the game can be seen from all directions and are arranged in arrays a1-a3 moving in the same or different directions, as well as with the same or different speeds. The sequence of all icons can be fixed in each array and therefore hold the same position in each array. When the game starts, the arrays move in the horizontal direction and stops at the payline. According to another operating mode, the positions of the icons are not fixed on the arrays because, when the game starts, the arrays move in horizontal direction and accelerate in such a way to become not recognisable. The virtual order of the icons on the arrays can therefore be changed during the game and be different when the arrays stop at the payline of each player station.

The slot device 60′ of the embodiment shown in FIG. 18 is similar to the embodiment of FIG. 17, but the player stations s1-s4 are mutually spaced even if they belong to the same slot device.

In the embodiments of FIGS. 17 an 18, a single computer unit 69 can be provided to run both a first program to control the game and a second program to control the screen.

Otherwise, in modular version, each player station is provided by its own game computer unit where the same first program runs to control the game at that player station, and a distinct computer unit is provided to run a second program which controls the screen.

The cabinets of the embodiments shown in FIGS. 17 and 18 can be made with different shapes, as for example that shown in FIG. 19 with slanted portions or that shown in FIG. 20 with a vertical straight configuration.

While the preferred embodiments of the invention have in common a flat shaped horizontal or vertical screen to enable both single and multiple player games in a more attractive way, other embodiments of slot devices operating according to the method of the present invention can be envisaged.

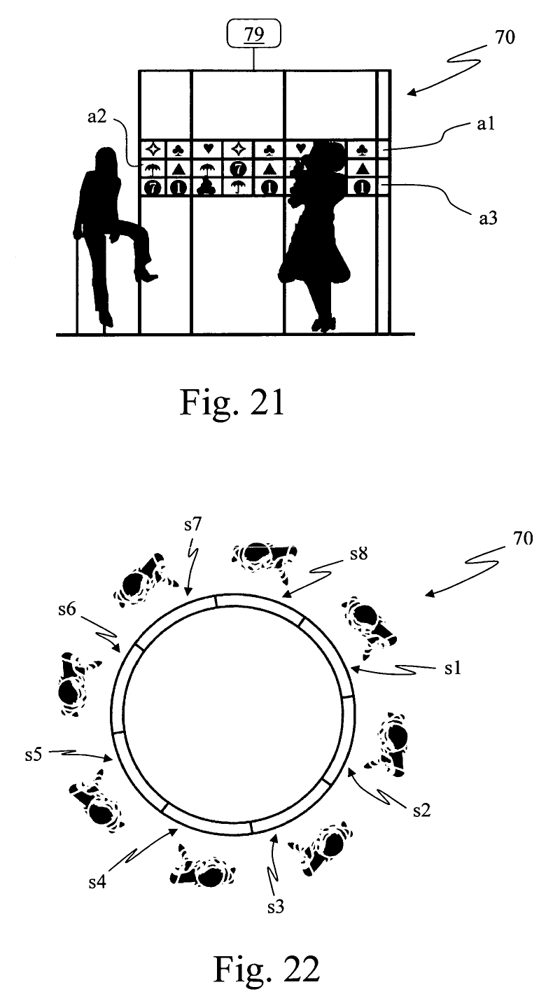

For example, a further embodiment of the present invention is shown in FIGS. 21 and 22, where the slot device 70 is made in the form of a cylindrical column.

The slot device 70 comprises arrays a1-a3 displayed or projected on the screen. The player stations are set at the column cylinder periphery. Eight player stations s1-s8 are shown in FIG. 22 but their number can be different as a function of the size of the column. A single computer unit 79 is provided to run both a first program to control the game and a second program to control the screen. The icon combinations are read from the paylines at each player station. Paylines of the column cylinder shaped slot device function similar to those in ordinary slot devices.

Paylines are predetermined or can be chosen by a player by pressing buttons or the like before the start of the game. The paylines are characterized either on the inner side, between the housing and the screen or on the back of a protective transparent housing.

The paylines of the cylindrical column device are in straight lines, in curves or in refracted lines as is common also with ordinary slot devices.

The payline with the prize winning combination of the icons becomes visible, blinks or is illuminated. Paylines can be brought onto the transparent material as transparent conductors and as transparent electroluminescent elements, or as mini LED or LCD.

Alternatively, The paylines can be a part of the basic picture of the game and thus an additional transparent electroluminescent layer is not necessary required.

It is clear that column slot devices can also be made in different shapes with respect to cylindrical shape of the embodiment of FIGS. 21 and 22.

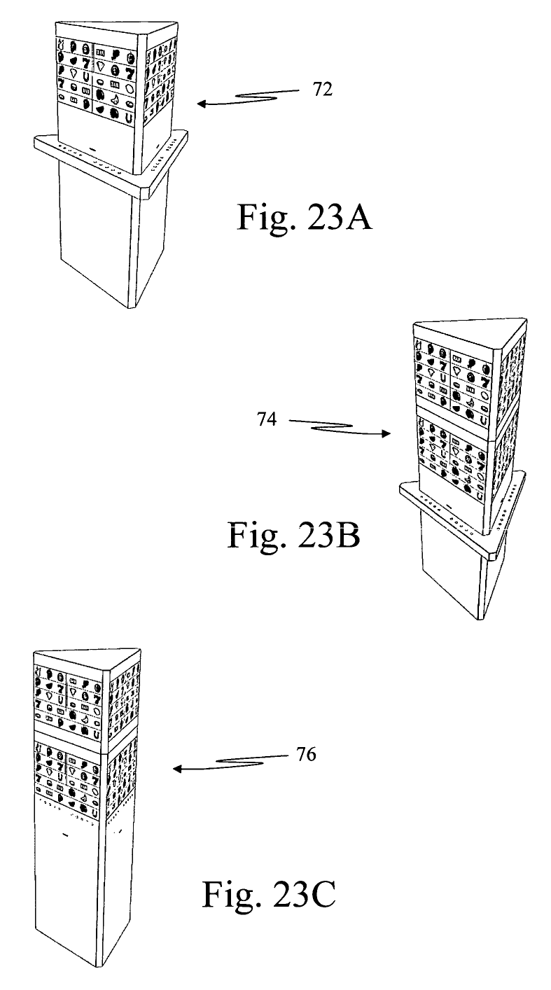

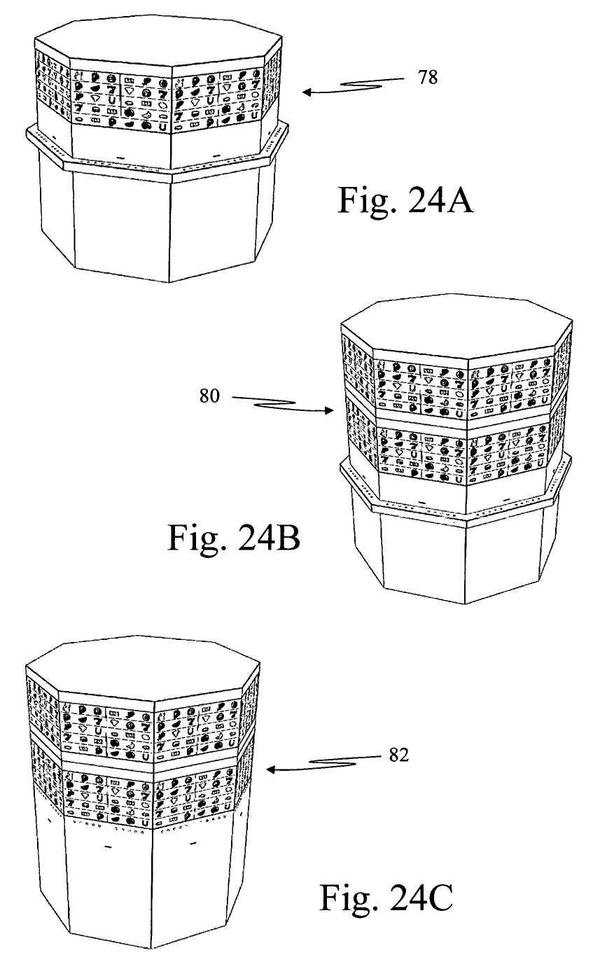

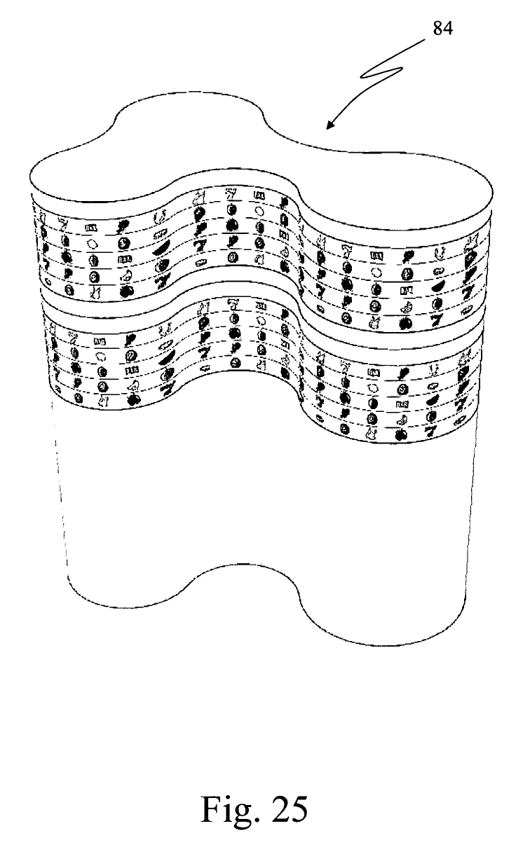

The column could be made in the form of parallelepiped shapes with any kind of polygonal base, as shown for example in FIGS. 23A, 23B and 23C where the devices 72, 74 and 76 have a triangular base, or also for example an octagonal base as shown for the devices 78, 80 and 82 in FIGS. 24A, 24B and 24C. Moreover, the column could be in the form of a cylindrical form with curved but non-circular base, as shown for example in FIG. 25 with the reference number 84.

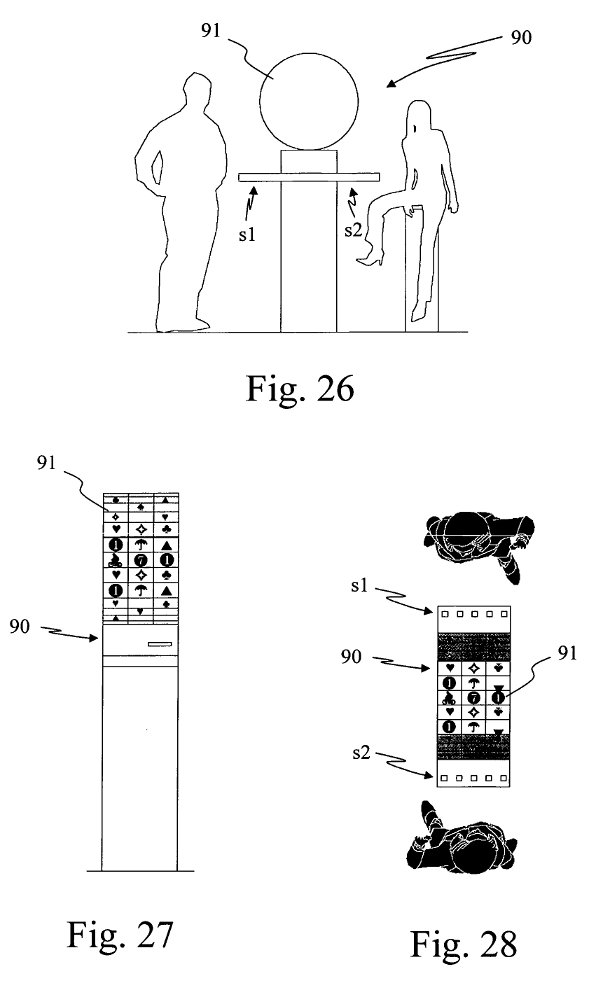

Another possible embodiment of an electronic slot device according to the present invention could be that shown in FIGS. 26, 27 and 28, where the device 90 has a screen 91 made in the form of a “drum” with only two player station s1 and s2.

The array of icons are displayed on the surface of the drum 91 as in the traditional slot machines, but they move from player station s1 to player station s2.

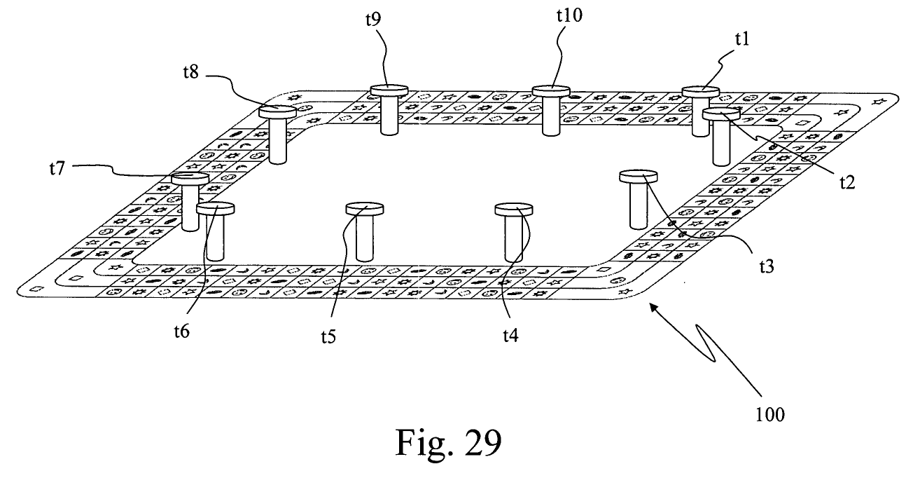

Still another embodiment of a slot device having a flat shaped screen is shown in FIG. 29, where the device 100 is integrated into a floor. Player terminals t1-t10 can be placed for example inside the area delimited by the array of icons and, as in the embodiment of the video wall shown in FIG. 14, allow each player to interact with one or more playing areas at the same time.

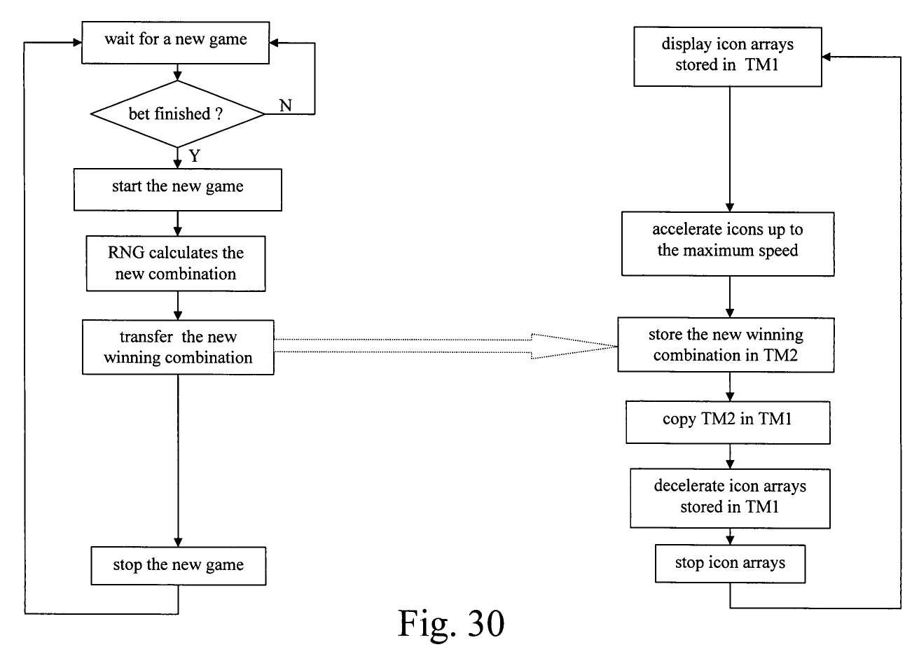

FIG. 30 shows a flow diagram for the operation of both the game program (blocks 200-250) and the screen program (blocks 300-350).

When the game program is waiting for starting a new session game at block 200, the screen program displays the combination of the previous session game stored in a first temporary memory TM1 (block 300). The game program remain in this condition, by cycling between the decision block 210 and the block 200, until the players have placed all their bets.

At the end of the betting phase, the new game is started (block 220) and the screen program start to accelerate the icons shown on the screen (block 310), i.e. those stored on the first temporary memory TM1; icons are moved independently to each other from one player station to another with increasing speed until a maximum speed is reached in which the icons become unperceivable.

The game program then calculate the winning combination for the current game (block 230) and then transfers the same (block 240) to the screen program, but without showing the same on the screen. Indeed, the screen program only stores the new winning combination in a second temporary memory TM2 (block 320).

Then the screen program replaces the previous winning combination stored in TM1 with the new winning combination stored in TM2 (block 330) while the icons on the screen are still unperceivable. The new winning combination, now stored in TM1, is then decelerated (block 340) and then stopped (block 350) when the game program stop the new current game (block 250).

Many changes can be made to the embodiments disclosed above without departing from the scope of the present invention. For example, the number of arrays, icons, player stations and player terminals, as well as the number of primary/bonus games and the kind of the bonus games here shown as example, can be different from those actually depicted. The path followed by each array between one player station to an adjacent one can also be different from that substantially straight and parallel shown for example in the drawings.

1. An electronic slot device including one or more player stations, at least one screen to display icons arranged in arrays and at least one electronic control unit, said at least one screen having one or more playing areas corresponding to said one or more player stations, characterized in that said at least one electronic control unit is programmed to display all the icons available in the game on said at least one screen, at the same time, at all said player stations.

2. The device according to claim 1, wherein at least one game computer unit is provided to run a first program which controls the game, and wherein a screen computer unit is provided to run a second program which controls at least the movement of the icons on said at least one screen on the basis of data and commands received by said first program.

3. The device according to claim 2, wherein said game computer unit and said screen computer unit consist of a single computer unit which runs both said first program to control the game of all the player stations and said second program to control said at least one screen for all the player stations.

4. The device according to claim 2, wherein one or more game computer units are provided for the corresponding one or more player stations to run the same first program in each of the player stations, and wherein said screen computer unit which runs said second program to control said at least one screen for all the player stations is a distinct computer unit with respect to said game computer units.

5. The device according to claim 1, wherein the device is composed of modular units connected to each other, each modular unit including a game computer unit to run a same first program to control the game, and wherein all the modular units are connected to a single screen computer unit which runs a second program to control said at least one screen for all the modular units.

6. The device according to claim 1, wherein interface means are provided to interact with said one or more player stations or one or more of said playing areas.

7. The device according to claim 1, wherein said at least one screen has a flat shape and a size sufficient to display at the same time all the icons available in the game at all said player stations.

8. The device according to claim 1, wherein said one or more player stations have a flat shaped screen without any part of the device interposed between said one or more player stations and said flat shaped screen to enable a player to have visible control at the same time to all the icons available in the game at all said player stations.

9. The device according to claim 1, wherein said one or more player stations have a flat shaped screen without any part of the device interposed between said one or more player stations and said flat shaped screen to enable all the players to have visibility to all the other players and all said player stations.

10. A method for operating an electronic slot device having one or more player stations, at least one screen to display icons arranged in arrays and at least one electronic control unit, said at least one screen having one or more playing areas corresponding to said one or more player stations, characterized in that all the icons available in the game are displayed on said at least one screen, at the same time, at all said player stations.

11. The method according to claim 10, characterized by including the steps of:
a) running a first program on a game computer unit to control the game;
b) running a second program on a screen computer unit to run a second program which controls at least the movement of the icons on said at least one screen on the basis of data and commands received by said first program.

12. The method according to claim 11, wherein each array of icons of a previous session of the game is stored in a corresponding first temporary memory of said screen computer unit and each array of icons of a new session of the game is stored in a corresponding second temporary memory of said screen computer unit.

13. The method according to claim 11 wherein, at the start of a new game session, the arrays of icons stored in said first temporary memory and currently shown on said at least one screen are moved independently to each other from one player station to another with an increasing speed until a maximum speed is reached in which the icons become unperceivable.

14. The method according to claim 11 wherein, during a new game session, each array of icons corresponding to the result of the new session game is calculated by said first program and stored in said second temporary memory without being shown on said at least one screen.

15. The method according to claim 11 wherein, at the end of a new game session, the data of said first temporary memory are replaced by the data of said second temporary memory while the icons of the arrays shown on said at least one screen are still unperceivable, and then each array of icons corresponding to the result of the new session game is moved independently to the others from one player station to another with a decreasing speed until each array stops.

16. The method according to claim 10, wherein said arrays are electronically displayed on said at least one screen.

17. The method according to claim 10, wherein said arrays are projected on said at least one screen.

18. The method according to claim 10, wherein all the icons involved in the game are shown on said at least one screen.

19. The method according to claim 10, wherein a third program is provided to display multimedia contents including commercials, video spots movies or other kind of entertainment/commercial media on said at least one screen.

20. The method according to claim 19, wherein said multimedia contents are displayed on said at least one screen as a background during the course of a game.

21. The method according to claim 19, wherein said multimedia contents are displayed on said at least one screen before a game starts or after a game is finished.

22. The method according to claim 19, wherein said multimedia contents are displayed on said at least one screen in correspondence of playing areas not involved by the game.

23. The method according to claim 19, wherein said third program to display multimedia contents is run on said screen computer unit or on a third computer unit which is different from said game computer unit.

24. The method according to claim 10, wherein each of the player stations can be switched from a community game to a single player game.

25. The method according to claim 10, wherein said at least one screen has a flat shape and a size sufficient to display at the same time all the icons available in the game at all said player stations.
